(19) United States
(12) Patent Application Publication
(10) Pub. No.: US 2008/0134780 A1
(43) Pub. Date: Jun. 12, 2008

(54) LIQUID MEASURING DEVICE AND METHOD OF USING SAME

(76) Inventor: MICHAEL MICHELI, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/951,982

(22) Filed: Dec. 6, 2007

Related U.S. Application Data
(60) Provisional application No. 60/869,062, filed on Dec. 7, 2006.

(51) Int. Cl. G01F 19/00

(52) U.S. Cl. 73/428

(57) ABSTRACT

A liquid measuring device which affixes to vitamin, supplement or other types of bottles with a screw top. This device allows a measurement of the liquid to be filled into the device for consumption or use. This device is useful when the user needs to take a particular amount of liquid vitamins, medicine or other type of supplement. Rather than use a second apparatus such as a spoon or a syringe this device, allows the user to always measure out an exact portion of liquid for consumption.

### CROSS-REFERENCE TO RELATED APPLICATIONS

This application claims the benefit of U.S. Provisional Patent Application Ser. No. 60/869,062, filed Dec. 7, 2006, entitled “Liquid Measuring Device and Method of Using the Same” which is hereby incorporated by reference in its entirety.

### FIELD OF INVENTION

The present invention relates to liquid measuring devices.

### BACKGROUND OF THE INVENTION

Previously, a user who was going to take a specific amount of daily supplements, vitamins or medicine for consumption needed to specifically measure out an amount in a separate cup and/or other separate measuring device. This method was cumbersome in that the amounts measured were not exact, a separate measuring device was required, and unnecessary spills occurred.

### SUMMARY OF THE INVENTION

The present invention involves a liquid measuring device that is capable of attaching to various types of bottles, such as those used for drinking, or taking liquid medicine, supplements or vitamins. This invention allows for the user to measure a specific amount of liquid for consumption.

This device overcomes the above drawbacks in that it is a unitary device that can be attached to a bottle and left resident on the bottle until the total amount of liquid (e.g., liquid vitamins, supplements or medicine) from the bottle has been consumed. Once a bottle is empty this device can be re-used on a second bottle. Alternatively the device can be switched from bottle to bottle, when needed. The manufacture costs of this device are minimal allowing the consumer production costs production to be very reasonable. A consumer may use multiple devices so that each bottle that requires precise measurements for consumption is fitted with a respective device. The device can be manufactured in various sizes allowing the user to perhaps purchase a device which holds an ounce and contains a measurement inscription on its side so that various portions of the ounce can be measured out such as a half or a quarter.

In one embodiment this device comes with a plastic coupling adapter which will allow the main unit to properly screw onto various sizes and shape to bottle openings. This adapter has a male threading on the top which screws into the female opening of the main unit of the device and female threading on the bottom which will screw into the male bottle openings for a secure fit. The top male threading will always be the same size while the bottom female threading and opening will vary to fit. The bottom female portion of the adapter comes in a variety of sizes to fit on the different sizes of bottle openings and thread configurations being sold on the market.

### BRIEF DESCRIPTION OF DRAWINGS

The accompanying drawings, which are incorporated in and constitute a part of the specification, illustrate embodiments of the invention and, together with the description, serve to explain the objects, advantages, and principles of the invention. In the drawings,

FIG. 1 is a perspective view of an embodiment of the liquid measuring device attached to a bottle;

FIG. 2 is a side elevational view of the liquid measuring device of FIG. 1;

FIG. 3 is a top plan view of the liquid measuring device of FIG. 1;

FIG. 4 is a cross-sectional view of the liquid measuring device of FIG. 1 showing the thumbscrew valve in an open position enabling liquid to flow into the device; and

FIG. 5 is a cross-sectional view of the liquid measuring device of FIG. 1 showing the thumbscrew valve in a closed position blocking the flow of liquid to or from the device.

### DESCRIPTION OF EMBODIMENT OF INVENTION

After reading this description it will become apparent to one skilled in the art how to implement the invention in various alternative embodiments and alternative applications. However, with all the various embodiments of the present invention will be described herein, it is understood that these embodiments are presented by way of an example only, and not limitation. As such, this detailed description of various alternative embodiments should not be construed to limit the scope or breadth of the present invention as set forth below.

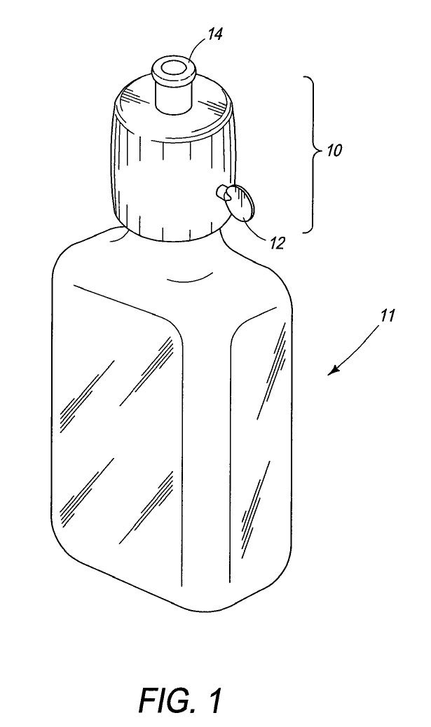

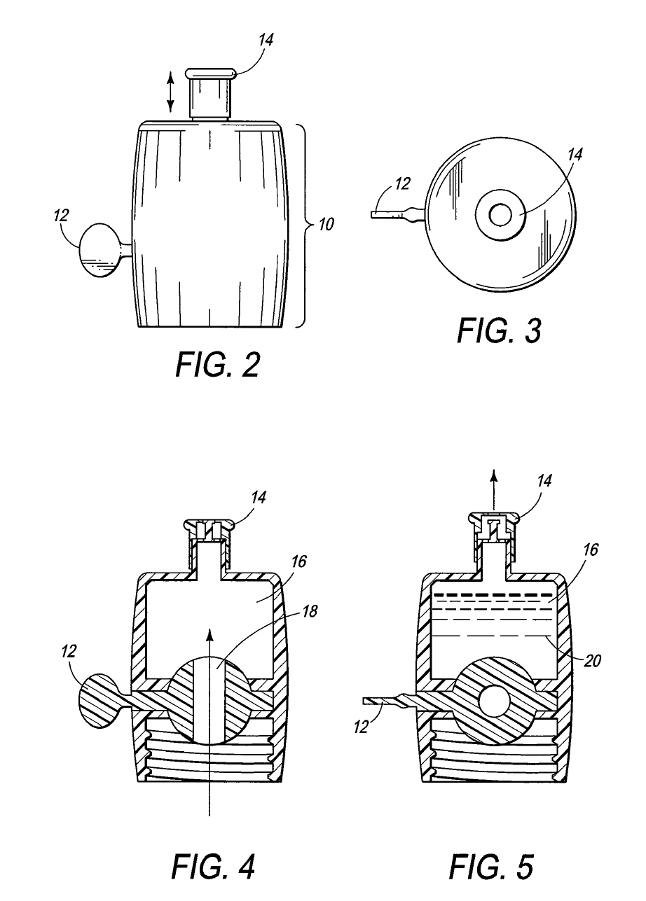

With reference to FIGS. 1-5 an embodiment of a liquid measuring device 10 is shown attached to a bottle 11. This device 10 is composed of a unitary unit which includes an internally threaded portion that screw onto the externally threaded top portion of most standard bottles and a reservoir to hold liquid 16. In one embodiment the liquid measuring device comes with a coupling adapter. This adapter can be made of plastic or other malleable material. The adapter will allow the device to properly screw to various bottle opening sizes and shapes. The adapter has male threading on the top which screws into the female opening of the device and female threading on the bottom which will screw onto the male opening of the bottle for a secure fit. The top male threading of the adapter will always be the same size while the bottom female will vary to fit different sizes of bottles. The female threading of this adapter can be made in multiple sizes to fit the existing bottles on the market.

The device 10 includes a thumbscrew valve 12 with flat operative member located on the exterior surface of the device 10 to be engaged between a user's thumb and finger for controlling the valve 12. If the thumbscrew valve 12 is rotated to the position shown in FIG. 4, an open bottom of the device 10 communicates with an interior chamber or reservoir 16 of the device allowing flow between the bottle 11 and the liquid measuring device 10 and vice versa. If the thumbscrew valve 12 is turned to its shutoff position shown in FIG. 5, flow between the bottle 11 and the liquid measuring device 10 and vice versa is cut off. In alternate embodiments the thumbscrew valve can be replaced with a different type of valve which allows liquid to either freely pass through or be blocked.

In one or more embodiments, the device 10 measures one or more fluid volumes (e.g., ½ fluid ounce, 1 fluid ounce, 1½ ounces, 2 fluid ounces, 1 teaspoon, 1 tablespoon, etc.) In an embodiment, the measuring device 10 includes fluid volume indicators showing fluid volume increments (e.g., ½ fluid ounce, 1 fluid ounce, 1½ ounces, 2 fluid ounces, etc.). In another embodiment the device 10 measures only a specific volume (e.g., 1 ounce size, 1 teaspoon size, 1 tablespoon size).

In one or more embodiments, the device 10 is manufactured in various colors to designate the volume of liquid held by each individual device 10. For example, a red device 10 equals 1 ounce, a green device 10 equals 1.5 ounce, and a blue device 10 equals 2 ounces. In a preferred embodiment, the measuring device 10 is made of a clear, transparent or translucent material so that the interior liquid can be seen by a user. At the distal end of the device 10 there is a movable nipple mechanism 14 that is movable in the direction of the arrows shown. The nipple mechanism is pulled out, away from the device 10, to allow the user to drink or squirt the liquid contained in the measuring device 10 into a user's mouth or another container, and is pressed in, toward the device 10, to prevent flow out of the device 10, for example, when measuring a volume of fluid. In alternative embodiments, the nipple mechanism 14 includes different configurations/constructions such as, but not limited to, a flexible-type material that contain a small hole such as a baby bottle nipple or a flexible bite valve (e.g., a Camelback® bite valve).

The entire device 10 screws or twists onto the threaded top of standard screw top bottles. The device 10 is reusable, is transferable from bottle to bottle, and/or comes with an adapter to allow it to be transferable from bottle to bottle. Further this device is made so that it is dishwasher-safe.

In one or more implementations of the embodiment(s) described above and shown herein, the device 10 includes one or more holes, vents, check valves, or other mechanisms for allowing air to escape the device 10 when pressure is imparted to the bottle or when the bottle is turned upside-down with the device 10 thereon.

The device 10 will now be described in use. To measure a specific volume of liquid from the bottle 11, the device 10 is first screwed onto the threaded top of the bottle 11. Then, referring to FIG. 4, the thumbscrew valve 12 provided in the open position. Squeezing the bottle 11 (assuming the bottle is squeezable), with the nipple mechanism 14 in the closed position, causes pressurized liquid in the bottle 11 to flow into the reservoir 16 through channel 18 until the desired fluid volume is achieved. Alternatively, with the thumbscrew valve 12 provided in the open position and the nipple mechanism 14 in the closed position, the device 10 and bottle 11 are turned upside down so that liquid in the bottle 11 flows into the reservoir 16 through channel 18 until the desired fluid volume is achieved. Any desired indicator marking(s) (e.g., oz, ml, tsp) is placed on the device 10 to indicate fluid volume amounts.

Referring to FIG. 5, the thumbscrew valve 12 is rotated to the position shown, to close the channel 18. With the valve 12 in this position, the liquid that is contained in the reservoir 16 cannot exit the reservoir 16, back into the bottle 11. This allows the measured fluid volume to remain within the reservoir 16.

Once the liquid volume is measured, the liquid exits the reservoir 16 through the nipple mechanism 14 by first pulling the nipple mechanism 14 out and then turning the device 10 and bottle 11 upside down so that the liquid flows out of the device 10, through the open nipple mechanism 14. The reservoir 16 can have lines 20 affixed or imprinted on its exterior to show measurements of liquid in the reservoir. The liquid is poured directly into a user's mouth, another glass, etc. for consumption/drinking.

The device 10 is unscrewed from the top of the bottle 11 for washing/cleaning the device 10 and/or using the device 10 on a different bottle 11. Further, if it is desired to measure a different volume of liquid, a different-volume device 10 is added to the top of the bottle 11 to measure a different volume of liquid.

In alternative embodiments, one or more additional and/or different types of valves and/or tops/nipples are used for allowing fluid into and/or out of the device 10 for measuring a fluid volume. For example, but not by way of limitation, the valve 12 is a one-way valve that only allows fluid flow into the reservoir 16. In an embodiment, where a squeezable bottle is used, with a squeezable bottle and attached device 10 in an upright position, the bottle is squeezed, causing fluid to flow through the one-way valve and into the reservoir 16 until the desired volume of fluid is measured.

The measuring device 10, which is attachable to the tops of most bottles 11, eliminates the problems in the past with having to measure out an amount in a separate cup and/or other separate measuring device (e.g., cumbersome, imprecision, unnecessary spills occurred). This device overcomes the above drawbacks in that it is a unitary device that is attachable to the bottle 11 and left resident on the bottle 11 until the total amount of liquid (e.g., liquid vitamins, supplements or medicine) from the bottle 11 has been consumed. Once a bottle 11 is empty, the device 10 is washed/cleaned and re-used on a second bottle. Alternatively, the device 10 is switched from bottle to bottle, when needed. A consumer may use multiple devices 10 so that each bottle that requires precise measurements for consumption is fitted with a respective device 10.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein. The invention, therefore, is not to be restricted except in the spirit of the appended claims.

1. A measuring device, comprising:
a unitary unit with an internally threaded portion configured to screw onto the externally threaded top of a bottle;
a reservoir within the unitary unit configured to hold liquid;
a valve on one side of the fluid reservoir configured to open and close allowing liquid to pass or be held within the reservoir;
a operative member on the exterior surface of the unitary unit configured to open and close the valve allowing liquid to pass into the reservoir; and
a nipple mechanism to release liquid from the unitary unit.

2. The device of claim 1, further including an adapter having one end configured to attach to the externally threaded top of the bottle and an opposite end configured to attach to the internally threaded portion of the device.

3. The device of claim 2, wherein the adapter is configured to attach to the tops of bottles having different external thread patterns.

4. The device of claim 1, wherein the operative member on the exterior surface of the device is a thumbscrew.

5. The device of claim 1, wherein the nipple mechanism is a push-pull mechanism.

6. The device of claim 1, wherein the nipple mechanism is made of a flexible material with a pin point hole to allow liquid flow there through.

7. The device of claim 1, wherein the device is configured to measure a fluid volume from the group consisting of an ounce, a teaspoon, a tablespoon, and an increment thereof.

8. The device of claim 7, wherein the device includes an indicator displaying fluid volume increments.

9. The device of claim 1, wherein the reservoir is made of a material from the group consisting of a clear material, a transparent material, and a translucent material.

10. The device of claim 1, wherein the device is one of multiple different colored devices, each color representing a different-volume device.

11. A method for dispensing a set volume of liquids comprising:
screwing a unitary unit, which includes a reservoir, a valve, a nipple, and a operative member, onto the top of a screw top bottle;
opening the valve with the operative member;
squeezing or turning the bottle upside down causing the liquid in the bottle to flow into the reservoir;
through the valve; and
transferring the liquid from the reservoir through the nipple.

12. The method of claim 11, wherein the operative member on the exterior surface of the device is a thumbscrew.

13. The method of claim 11, a push-pull mechanism.

14. The method of claim 11, wherein the nipple mechanism is made of a flexible material with a pin point hole to allow liquid flow there through.

15. The method of claim 11 wherein the device is configured to measure a fluid volume from the group consisting of an ounce, a teaspoon, a tablespoon, and an increment thereof.

16. The method of claim 15 wherein the device includes an indicator displaying fluid volume increments.

17. The method of claim 11, wherein the reservoir is made of a material from the group consisting of a clear material, a transparent material, and a translucent material.

18. The method of claim 1, wherein the device is one of multiple different colored devices, each color representing a different-volume device.
